(19) United States
(12) Patent Application Publication
(10) Pub. No.: US 2009/0034576 A1
(43) Pub. Date: Feb. 5, 2009

(54) LINEWIDTH-NARROWED EXCIMER LASER CAVITY

(75) Inventor: John Hoose, Fairport, NY (US)

Correspondence Address: RISSMAN JOBSE HENDRICKS & OLIVERIO, LLP, 100 Cambridge Street, Suite 2101, BOSTON, MA, 02114, US

(73) Assignee: Newport Corporation, Irvine, CA (US)

(21) Appl. No.: 11/833,708

(22) Filed: Aug. 3, 2007

(51) Int. Cl. H01S 3/08

(52) U.S. Cl. 372/96

(57) ABSTRACT

A double-grating excimer laser cavity is disclosed which includes a first multilayer dielectric diffraction grating comprised of a dielectric stack having a plurality of continuous layers with alternating high and low refractive indices, and a nonmetallic diffraction grating disposed on the top layer of the plurality of layers. The nonmetallic diffraction grating is a single pair of layers made of a low refractive index dielectric material and a high refractive index dielectric material. Grooves extend through the pair of layers. The diffraction grating has a diffraction efficiency of greater than 85% at the laser emission wavelength. The laser produces a laser output beam with a narrow spectral linewidth which is suitable, in particular, for lithography applications.

### FIELD OF THE INVENTION

The invention relates to a system and method for producing narrow linewidth emission from lasers and, more particularly, to a grating cavity for excimer lasers configured to produce UV emission at high optical output power and with a narrow emission linewidth.

### BACKGROUND OF THE INVENTION

Lasers are used, for example, for material processing and in semiconductor manufacturing, where the small feature size of today's circuit elements and interconnects demands very fine structural feature definition on the scale of tens of nanometers. Lasers are also employed in the production of optical gratings, such as volume gratings, holographic gratings, as well as in the distributed feedback (DFB) and distributed Bragg reflection (DBR) sections in diode lasers and optical fibers. The dimensions of the achievable structural features are related to the laser wavelength and to laser linewidth. Modern semiconductor fabs increasingly use wavelengths in the deep ultraviolet (UV) and soft x-ray lithography for mask exposure. In addition, the definition of these small features also requires novel mask designs, such as phase masks, and the narrowest attainable laser linewidth, because a spectral distribution of the illuminating source would tend to wash out the desired features.

Suitable light sources operating in the UV and deep UV are excimer lasers, such as ArF, KrF excimer lasers, which have an emission linewidth of about 300 pm (full width half maximum or FWHM) at wavelengths of less than 250 nm.

In one prior art technique, an excimer laser cavity is formed by an output coupler in form of a partially reflecting mirror and an echelle grating, reducing the linewidth of a KrF laser from 300 pm to about 0.8 pm. However, some applications, for example, submicron lithography (<0.25 μm) for integrated circuit fabrication requires linewidth of about 0.5 pm or less. In another prior art approach, a double-pass configuration with a single echelle grating was used, whereby the laser radiation propagating in the cavity impinges on the grating twice with different polarization directions. However, this particular arrangement is not practical for generating the high laser output power required for high-throughput mask exposure due to the relatively low diffraction efficiency of conventional echelle gratings. The diffraction efficiency is typically about 60% per pass, therefore, the double pass loss from the gratings alone would be 0.6×0.6=36% which would be too for applications in semiconductor manufacturing.

Another prior art approach for decreasing the bandwidth places etalons inside the laser cavity to filter out unwanted wavelength regions of the emission spectrum. However, etalons are susceptive to optical damage which makes them unsuitable for high power laser applications.

Another prior art approach achieves linewidth narrowing with a grism (prism-grating) which combines the refractive properties of a prism with the diffractive properties of a grating. Grisms can be designed to operate as highly reflective rear mirrors or as partially reflective output couplers. The development of integrated circuits with an ever increasing component density and decreasing feature size requires high power illumination sources operating at shorter wavelengths and having a narrow emission linewidth, while retaining high efficiency. Accordingly, there is a need for high-efficiency optical modules that are able to further narrow the optical linewidth of excimer lasers without sacrificing output power and electrical-to-optical conversion efficiency.

### SUMMARY OF THE INVENTION

The invention is directed to a laser cavity employing a plurality of gratings for narrowing the linewidth of the laser output beam.

According to one aspect of the invention, a line-narrowed excimer laser system includes a laser cavity with a gain medium, an output coupler and a reflector assembly, wherein the reflector assembly includes a first multilayer dielectric diffraction grating and a second diffraction grating arranged in sequence. The first multilayer dielectric diffraction grating receives laser light from the gain medium at a first angle of incidence of less than 800 with respect to the grating normal of the first grating and wavelength-selectively diffracts the laser light towards the second grating. The second diffraction grating operates in a Littrow configuration and diffracts the received laser light back to the first grating where it is additionally diffracted. wherein only a portion of the additionally diffracted laser light that is substantially aligned with the optical axis of the laser cavity effectively contributes to laser emission through the output coupler, thereby narrowing the linewidth of the laser emission wavelength relative to the wavelength distribution of the laser light produced in the gain medium.

Embodiments of the invention may include one or more of the following features. The first multilayer dielectric diffraction grating may include a dielectric stack with a plurality of continuous layers, wherein each layer of the plurality of continuous layers comprises either a high refractive index dielectric material or a low refractive index dielectric material, wherein the high refractive index dielectric material and the low refractive index dielectric material have a difference in refractive index greater than 0.1, wherein the plurality of continuous layers has a top layer and a bottom layer, wherein the bottom layer is affixed to the substrate, and wherein each layer of the plurality of continuous layers comprises a continuous film. The first multilayer dielectric diffraction grating further includes a nonmetallic diffraction grating disposed on the top layer of the plurality of continuous layers and having a single pair of layers made of a low refractive index dielectric material having a first thickness and a high refractive index dielectric material having a second thickness, with grooves extending through the pair of layers, wherein each groove has a shape, and wherein the number of layers of the plurality of continuous layers and the first and second thickness the single layer are selected to achieve a diffraction efficiency of at least 85% at the laser emission wavelength.

The nonmetallic diffraction grating may operate in 3^{rd} order.

The dielectric stack or the substrate, or both, may be made of a dielectric material that is transparent to the laser emission wavelength. The dielectric material may be an oxide material, a fluoride material, a sulfide material and/or a selenide material. The single pair of layers may be made of materials that are substantially identical to those of which the continuous layers are made. The high refractive index dielectric material may be Al₂O₃ and the low refractive index dielectric material may be SiO₂. The thickness of the layers of the layer pair may be different from the thickness of corresponding layers of the continuous layers having substantially the same index of refraction. For example, the top Al₂O₃ layer of the layer pair may the thicker than the Al₂O₃ layers of the dielectric stack. The same applies to the SiO₂ layers.

Further features and advantages of the present invention will be apparent from the following description of preferred embodiments and from the claims.

### BRIEF DESCRIPTION OF THE DRAWINGS

The above and further advantages of the invention may be better understood by referring to the following description in conjunction with the accompanying drawings in which:

FIG. 1 illustrates in schematic form an exemplary embodiment of a double-grating laser according to the present invention;

FIG. 1A shows in more detail the diffraction angles of the double-gratings of FIG. 1;

FIG. 2 illustrates schematically an exemplary embodiment of a dielectric grating used with the embodiment of FIG. 1;

FIG. 3 shows the wavelength dependence of the diffraction efficiency of the grating of FIG. 2 for TM polarization at wavelengths around 193 nm;

FIG. 4 illustrates schematically another exemplary embodiment of a double-grating laser according to the present invention; and

FIG. 5 shows schematically the embodiment of FIG. 4 with an optional sensor.

### DETAILED DESCRIPTION

The methods and systems of the present invention as claimed and described herein are directed to a laser cavity, in particular an excimer laser cavity, with two gratings for narrowing the laser emission linewidth.

Gratings for wavelength selection in laser cavities are typically designed for operation in two different configurations. In one, more traditional configuration, the grating is blazed at a high angle, typically greater than about 79° and operates in an autocollimating (Littrow) mount. To obtain high wavelength discrimination, the incident beam should fill the entire grating, requiring either telescope lens or prism optics.

A large diffraction angle is beneficial for achieving high wavelength dispersion which in Littrow configuration can be expressed as:

$$\frac{\partial Θ}{\partial λ} = \frac{1}{cos Θ} * \frac{m}{d} \qquad ( Eq . 1 )$$

wherein ⊖ is the angle between the grating normal and the incident beam, m is the diffraction order and d is the grating period. As suggested by Eq. (1), the dispersion

$$\frac{\partial Θ}{\partial λ}$$

can be increased by operating the grating at a high diffraction order m and/or by having a small grating period d and/or by operating at almost grazing incidence (⊖=90°), however at the expense of diminished efficiency.

The equivalent halfwidth Δλ of the spectral distribution can be derived from Eq. (1) as:

$$\frac{Δ λ}{λ} = \frac{λ}{π \cdot l \cdot sin Θ} \qquad ( Eq . 2 )$$

wherein / is the length of the illuminated part of the grating and the angle ⊖ has the same definition as above.

In an alternative configuration, commonly referred to as Littman-Metcalf geometry, the grating is not arranged, as in the Littrow configuration, to essentially diffract the optical beam back on itself, but is instead used in low-order diffraction at a fixed angle of incidence in conjunction with a reflecting tuning element, for example, a mirror. Beam expansion before the grating is generally not required.

However, to achieve high wavelength discrimination, the Littman-Metcalf grating also tends to be operated at or near grazing incidence. Littman-Metcalf tuning is mostly done in first order, and 1800 g/mm, 2000 g/mm, and 2400 g/mm holographic gratings are preferred. The large angles of incidence of between 80° and 88° typically require a longer ruled width, necessitating large grating dimensions of, for example, 16.5×58×10 mm.

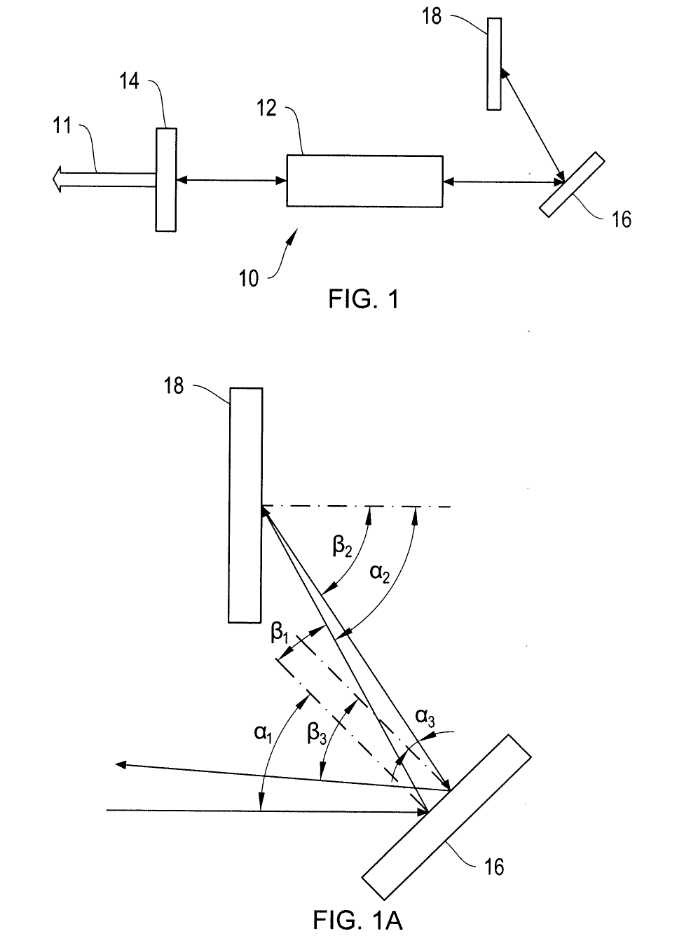

Turning to FIG. 1, a first exemplary embodiment of a laser system 10 according to the invention includes a laser chamber 12, an output coupler 14, a first grating 16 and a second grating 18 operating as a wavelength-selective reflector, and produces an output beam 11. Not illustrated are apertures, beam scrambler, etalons or prisms which may be required for optimal operation, but can be conventional and are not part of the invention,. The laser chamber 12 may be an excimer laser gain section, such as ArF or KrF. The output coupler 14 may be a partially reflecting mirror with, for example, about 10% reflectivity at the lasing wavelength, although other reflectivity values may be selected. The first grating 16 operates in a Littman-Metcalf configuration in 3^{rd} order at an angle of incidence, as measured from the grating normal, of less than 70°, and is designed to diffract about 90% of the incident laser power toward grating 18. Conversely, grating 18 is designed to operate in Littrow configuration (angle of incidence equals angle of diffraction), exhibiting 95% diffraction efficiency in 3^{rd} order to diffract the light back to grating 16. Grating 16 then diffracts the light back to the laser gain medium in 3^{rd} order with approximately 90% diffraction efficiency.

FIG. 1A shows in greater detail the angular relationship between the incident and diffracted beams for the embodiment of FIG. 1. The beam from the laser chamber 12 is incident on first grating 16 at an angle α₁ with respect to the grating normal. For a certain wavelength λ, the diffracted beam encloses an angle β₁ with the grating normal and is incident on the second grating 18 at an angle α₂. Because grating 18 operates in Littrow mode, the diffracted beam at wavelength λ exits the grating 18 with the same angle β₂=α₂. A beam having a wavelength that is slightly different from λ, for example, λ+Δλ, is diffracted from the grating 18 at an angle β₂≠α₂ and is then incident on grating 16 at an angle α₃ and diffracted back into the laser chamber 12 at an angle β₃ different from angle α₁. The first grating 16 operates in a non-Littrow configuration, i.e., the incident beam is diffracted with a diffraction angle that is different from the angle of incidence.

Double grating reflectors have been successfully employed in, for example, dye lasers for narrowing the linewidth of the output beam. One example is the QuantaRay Dye Laser System commercially available from Newport Instruments, Inc. which employs a grating arrangement similar to the one described by Shoshan et al. (I. Shoshan and U.P. Oppenheim, Optics Communications, Vol. 25, No. 3, June 1978). The angle of incidence on grating 16 in the systems described in the references was close to grazing incidence, illuminating the entire width of the first grating (equivalent to grating 16 in FIG. 1). Since these systems were dye lasers, for example, holographic gratings can be used which are readily manufactured and replicated. Moreover, the diameter of the output beam of a dye laser is typically less than 1-2 mm, which makes it possible to illuminate a commercially available grating having a width of about 60-120 mm at an angle of incidence of about 89°.

Excimer lasers pose a more serious challenge, because the diameter of their output beam can exceed 1 cm. Moreover, excimer lasers have high photon energy due to their short wavelength and also high photon flux which is required for applications in, for example, semiconductor processing. The combination of high photon energy and high photon flux can easily damage traditional ruled gratings, and more particularly holographic gratings. Production of large area ruled gratings is also very expensive.

Excimer lasers operating with a double grating configuration therefore require a novel design of the first grating 16 that can operate with high diffraction efficiency at an angle of incidence of, for example, 60° to 70° from the grating normal.

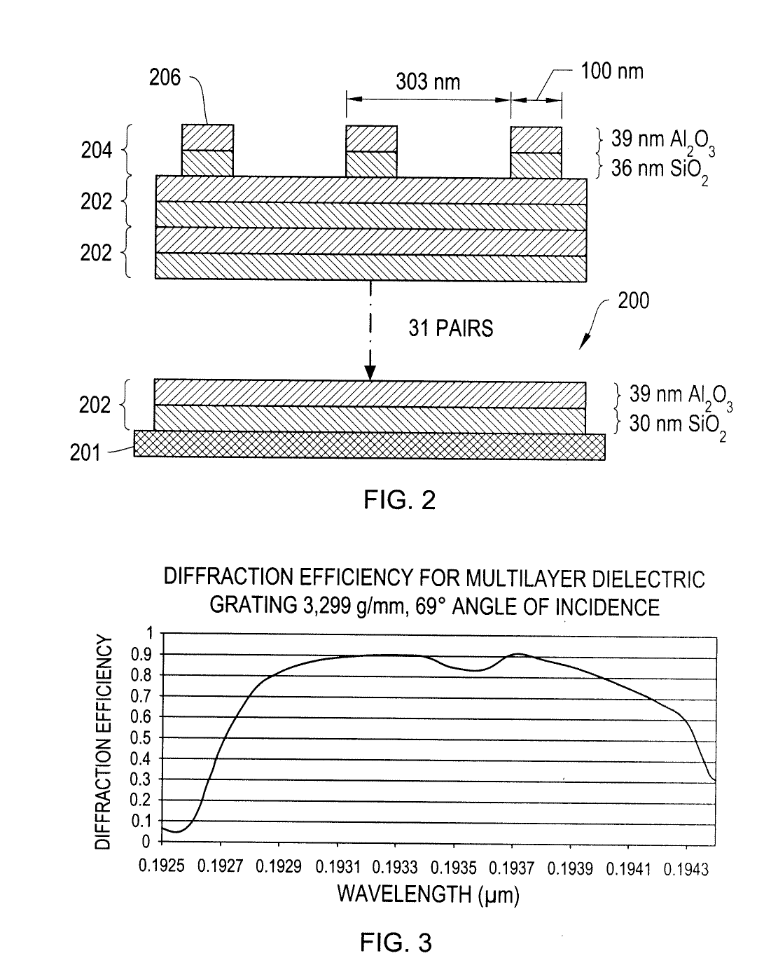

One embodiment of a grating suitable for this configuration with high diffraction efficiency is illustrated in FIG. 2. The exemplary grating 200 according to the invention is not blazed in the traditional sense and consists of substrate 201, on which a total of 34 layer pairs 202, alternating between a 30 nm thick SiO₂ layer (refractive index=1.54) and a 39 nm thick Al₂O₃ layer (refractive index=1.82), are deposited. The top layer pair 204 consists of a 36 nm thick SiO₂ layer followed by a 39 nm thick Al₂O₃ layer, which are disposed on top of the uppermost Al₂O₃ layer of layer pairs 202. The two top layers are etched down, for example, by ion beam etching to leave a grating pattern with 100 nm wide raised portions 206 and a grating period of 303 nm.

FIG. 3 shows the diffraction efficiency of the grating of FIG. 2 for an incident beam having an angle of incidence of about 69° and an angle of diffraction for the beam diffracted toward grating 18 of about 78.5°. As can be seen, the diffraction efficiency for TM polarization is about 92% at the design wavelength of about 193 nm. The illuminated grating width for a beam diameter of 3 m,m is then equal to 3/cos 69° mm or slightly more than 8 mm.

Grating 18 of FIG. 1 operates in Littrow configuration, i.e., almost all incident intensity is wavelength-selectively diffracted back toward grating 16 at the same angle (autocollimation), where it is diffracted a second time before it reenters the gain region, laser chamber 12. Grating 18 may be a conventional Littrow grating with a large blaze angle, but other recently developed grating with high efficiency at excimer laser wavelengths, such as a grating of the type disclosed in U.S. Pat. No. 6,958,859, may be employed. The grating may be operated, for example, in 3^{rd} order with a diffraction efficiency approaching 95% at a design wavelength of 193 nm. The optical power diffracted into the 0^{th}, 1^{st} and 2^{nd} order is essentially zero.

The wavelength dispersions of the sequentially arranged gratings 16,18 illustrated in FIG. 1 are additive. This will increase the wavelength selectivity over that of a single grating configuration and narrow the linewidth.

The linewidth of the laser operating with double gratings is narrowed for two reasons: (1) The laser beam propagating in the cavity has an inherent beam divergence, so that the angle α₁ has a certain angular spread; and (2) the wavelength of the beam has a certain linewidth Δλ depending on the laser cavity gain profile.

For example, the half-angle beam divergence δ⊖ for a laser operating at a wavelength of about 193 nm and having a Gaussian beam with an initial beam diameter of about 2 mm is about 0.2 mrad. The total angular dispersion obtained by the two gratings 16,18 in FIG. 1 can be expressed as:

$$\frac{\partial {β}_{3}}{\partial λ} = M ( \frac{2 {m}_{1}}{{a}_{1} cos {β}_{1}} + \frac{{m}_{2}}{{a}_{2} cos {β}_{2}} ) \qquad ( Eq . 3 )$$

wherein M is the beam magnification factor M=cos β₁/cos α₁ of the grating 16 and a₁ and a₂ are the groove spacings of grating 16 and 18, respectively. m₁ and m₂ are the respective diffraction orders of the gratings.

The single pass bandwidth (in cm⁻¹) of the laser cavity can be derived from Eq. (3):

$$\frac{δ λ}{{λ}^{2}} = \frac{2 \cdot δ Θ}{M {λ}^{2} ( \frac{2 {m}_{1}}{( {a}_{1} cos {β}_{1} )} + \frac{{m}_{2}}{( {a}_{2} cos {β}_{2} )} )} \qquad ( Eq . 4 )$$

The linewidth is narrowed because rays having wavelengths away from the center wavelength of 193.3 nm, for example, are off-axis and are not efficiently traversing the gain region 12.

Linewidth narrowing of the beam incident on grating 16 at an angle α₁=69°, then diffracted off grating 16 an angle β₁=78.58° toward grating 18, where the diffracted beam is incident at an angle α₂=68.22° and diffracted again at the same angle β₂=α₂ as illustrated in FIG. 1A is then diffracted back to grating 16. This 193.3 nm light is then incident at an angle of α₃=78.53° and then diffracts back toward the laser gain medium at an angle of β₃=69°. Light with a wavelength different from the desired center wavelength is then dispersed in angle according to Eq. (3).

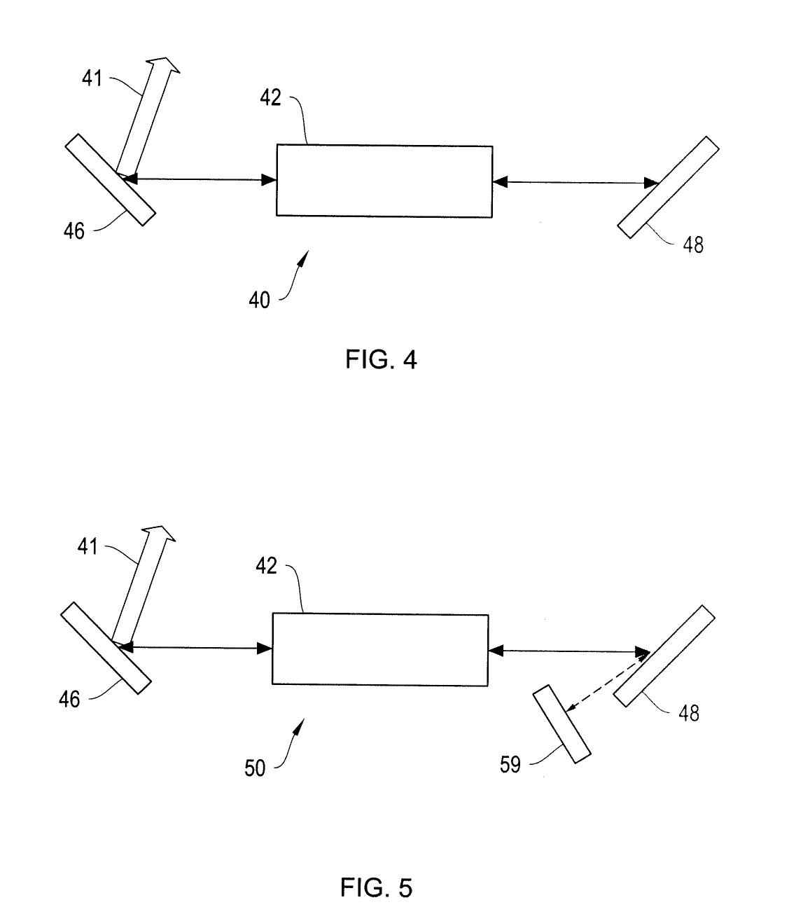

Turning now to FIG. 4, in another exemplary embodiment of the invention, a laser system 40 includes a laser chamber 42 with the gain medium, an output coupler in form of a first grating 46, and a retroreflecting second grating 48, with both gratings operating as wavelength-selective reflectors. The second grating 48 is designed for high reflectivity and can be formed on a metallic or semiconductor substrate having a reflective, such as dielectric, coating, whereas the first grating 46 operates as a partial reflector (e.g., about 10% reflectivity) to provide feedback into the laser cavity. Because the laser light makes typically about 3-4 round trips in the laser cavity, laser light incident on the second grating 48 at a wavelength that is slightly different from the center wavelength of the cavity will be diffracted back at an angle from the center axis of the laser and will therefore not be collinear with the incident beam. Because the off-wavelength retroreflected light will now be incident on grating 46 also at an angle different from the angle required for on-axis diffraction, it will be diffracted back into the laser chamber 42 with an even greater offset from the laser center axis. As a result, only laser light that substantially matches the design wavelength of the laser cavity (as discussed above with reference to Eqs. (3) and (4)) will effectively contribute to the laser gain, thus resulting in the desired linewidth narrowing.

Another embodiment of a laser system 50 with a double grating cavity is shown in FIG. 5. In this embodiment, the system 50 includes all the elements shown for the system 40 in FIG. 4, and in addition an optical detector 59 that indirectly measures the optical power of the laser output beam 41 from a diffraction order other than the order that is returned to the laser cavity 42. It will be apparent to those skilled in the art that a detector can also be incorporated in the laser system 10 of FIG. 1, with diffracted laser light from a different diffraction order directed to a detector (not shown).

Those skilled in the art will appreciate that other embodiments with more than two gratings are possible through a combination of the illustrated exemplary embodiments discussed above, for example, using two gratings as the high reflector and a single grating as output coupler. One of the two sequentially arranged gratings may be a transmission grating. It is only important that the gratings are designed and configured to provide sufficient wavelength dispersion and high diffraction efficiency while keeping the lateral dimensions of the gratings at a manageable size by moving away from grazing incidence or large blaze angle designs.

In another embodiment (not illustrated), similar to the embodiment depicted in FIG. 5, a weak signal from an adjacent diffraction order may be conditioned, for example, spectrally narrowed or phase- or polarization-shifted, and fed back into the cavity as a ‘seed’ pulse to modify the laser output. In this embodiment, detector 59 may be replaced with a suitable optical element, such as an etalon, a quarter-wave plate or a Faraday rotator.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A line-narrowed excimer laser system comprising:
a laser cavity comprising a gain medium, an output coupler and a reflector assembly,
the reflector assembly comprising a first multilayer dielectric diffraction grating and a second diffraction grating arranged in sequence, the first multilayer dielectric diffraction grating receiving laser light from the gain medium at a first angle of incidence of less than 80° with respect to the grating normal of the first grating and wavelength-selectively diffracting the laser light towards the second diffraction grating,
wherein the second diffraction grating operates in a Littrow configuration and diffracts the received laser light back to the first grating where it is additionally diffracted, wherein only a portion of the additionally diffracted laser light that is substantially aligned with the optical axis of the laser cavity effectively contributes to laser emission through the output coupler, thereby narrowing the linewidth of the laser emission wavelength relative to the wavelength distribution of the laser light produced in the gain medium.

2. The laser system of claim 1, wherein
the first multilayer dielectric diffraction grating comprises
a dielectric stack having a plurality of continuous layers, wherein each layer of the plurality of the continuous layers comprises either a high refractive index dielectric material or a low refractive index dielectric material, wherein the high refractive index dielectric material and the low refractive index dielectric material have a difference in refractive index greater than 0.1, wherein the plurality of the continuous layers comprises a top layer and a bottom layer, wherein the bottom layer is affixed to the substrate, wherein each layer of the plurality of the continuous layers comprises a continuous film; and
a nonmetallic diffraction grating disposed on the top layer of the plurality of the continuous layers and comprising a single pair of layers made of a low refractive index dielectric material having a first thickness and a high refractive index dielectric material having a second thickness, with grooves extending through the pair of layers, wherein each groove has a shape and wherein the number of layers of the plurality of the continuous layers and the first and second thickness are selected to achieve a diffraction efficiency of at least 85% at the laser emission wavelength.

3. The laser system of claim 1, wherein the dielectric stack comprises a dielectric material transparent to the laser emission wavelength.

4. The laser system of claim 1, wherein the dielectric stack comprises alternating layers of oxide material.

5. The laser system of claim 2, wherein the single pair of layers comprises alternating layers of oxide material.

6. The laser system of claim 1, wherein the high refractive index dielectric material comprises Al₂O₃ and the low refractive index dielectric material comprises SiO₂.

7. The laser system of claim 2, wherein the single pair of layers is made of a combination of materials substantially identical to a combination of materials of the continuous layers.

8. The laser system of claim 2, wherein the first and second thickness are different from a thickness of a continuous layer having a substantially identical index of refraction.

9. The laser system of claim 1, wherein the substrate comprises a material transparent to the laser emission wavelength.

10. The laser system of claim 3, wherein the dielectric material is selected from the group consisting of an oxide material, a fluoride material, a sulfide material and a selenide material.

11. The laser system of claim 2, wherein the nonmetallic diffraction grating operates in 3^{rd} order.
